(19) United States
(12) Patent Application Publication
(10) Pub. No.: US 2011/0174949 A1
(43) Pub. Date: Jul. 21, 2011

(54) Hanger Device

(76) Inventor: Stanley Kuo, Taipei (TW)

(21) Appl. No.: 12/944,182

(22) Filed: Nov. 11, 2010

(30) Foreign Application Priority Data
Jan. 19, 2010 (TW) 099201028

(51) Int. Cl. F16M 13/00

(52) U.S. Cl. 248/274.1

(57) ABSTRACT

The application discloses a hanger device. The mentioned hanger device comprises a body, a slide-able element, and an elastic element. According to this application, through the hook-shaped portions of the body and the slide-able element, the hanger device can be performed as an adjust-able clip to clipping at a desired position with different thickness. More preferably, besides being able to clip onto different thickness position, the hanger device can also provide at least one hanger for user to hang.

### BACKGROUND OF THE INVENTION

1. Field of the Invention

The present invention is generally related to a hanger device, and more particularly to a hanger device with multi-hanger function.

2.Description of the Prior Art

It is helpful for arrangement by using hook to hang thing(s) with proper weight. In the prior art, S-shaped hook is a general life goods. It is obviously that a S-shaped hook has two hooks formed in opposite direction. One hook of a S-shaped hook is employed to hang onto a desired position, and the other hook of the S-shaped hook is employed to hang the desired thing(s) on the S-shaped hook. S-shaped hook is very durable. However, the predetermined curve and size is not adjustable, and not really suitable for any desired hanging position.

Therefore, it is important to provide a hanger device with adjustable clipping function and easy for operating.

### SUMMARY OF THE INVENTION

According to the above, the present invention provides new hanger device to fulfill the requirements of this industry.

One object of the present invention is to employ a fixed hook-shaped portion and a slide-able hoop-shaped portion, so that the mentioned hanger device can be hanged onto a desired position.

Another object of the present invention is to employ a fixed hook-shaped portion and a slide-able hoop-shaped portion, so that the mentioned hanger device can be hanged onto different desired position with different thickness.

According to above-mentioned objectives, this present invention discloses a hanger device, wherein the hanger device comprises a body, a slide-able element, and an elastic element. The body comprises a first end, and a second end, wherein the first end comprises a first hook-shaped portion. The slide-able element comprises a second hook-shaped portion. The first hook-shaped portion and the second hook-shaped portion can be performed as a clip. The mentioned elastic element is positioned between the slide-able element and the second end of the body. The hanger device further comprises at least one hook on the body and the slide-able element. Therefore, the hanger device of this application can not only be performed as an adjust-able to hang onto different thickness, but also provide at least one hook for hanging.

### BRIEF DESCRIPTION OF THE DRAWINGS

FIG. 1 shows a hanger device according to one embodiment of this application; and

FIG. 2 shows an exploded view of a hanger device according to one embodiment of this application.

### DESCRIPTION OF THE PREFERRED EMBODIMENTS

What is probed into the invention is a hanger device. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

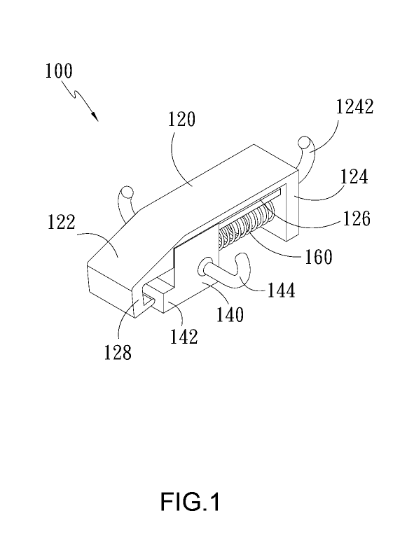

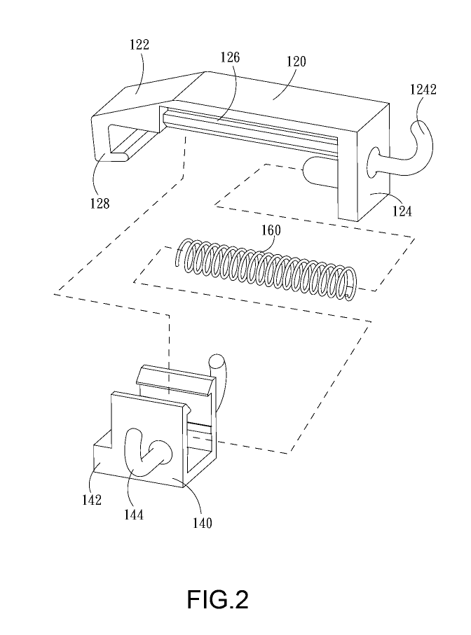

One preferred embodiment of this present invention discloses a hanger device. FIG. 1 presents a hanger device according to this embodiment. FIG. 2 presents an exploded view of a hanger device according to this embodiment. As shown in FIG. 1 and FIG. 2, the mentioned hanger device 100 comprises a body 120, a slide-able element 140, and an elastic element 160.

According to this embodiment, the body 120 comprises a first end 122, and a second end 124. The body 120 can further comprise at least a track 126. The track 126 is positioned between the first end 122 and the second end 124. The first end 122 of the body 120 can comprise a first hook-shaped portion 128.

The slide-able element 140 comprises an assembling portion, not shown in the figures, and the slide-able element 140 is assembled onto the track 126 of the body 120 through the assembling portion, so that the slide-able element 140 can slide in a predetermined pathway by the track 126. The slide-able element 140 can further comprise a second hook-shaped portion 142, as shown in FIG. 1 and FIG. 2. The mentioned first hook-shaped portion 128 and the second hook-shaped portion 142 can be employed as an adjustable clip, so that the hanger device 100 can be clipped onto a desired position through the first hook-shaped portion 128 and the second hook-shaped portion 142. In one preferred example of this embodiment, the body 120, the slide-able element 140 can be made of plastic, metal, alloy, wood, or other materials known by the one ordinary skilled in the art.

The elastic element 160 is positioned between the slide-able element 140 and the second end 124 of the body. In one preferred example of this embodiment, the elastic element 160 can be a spring.

According to one preferred example of this embodiment, as shown in FIG. 2, the body 120 can further comprise a protruding portion. The protruding portion is positioned at the inside wall of the second end 124 of the body 120. The mentioned protruding portion can be employed to assist assembling the elastic element 160 at the predetermined position. In one preferred example of this embodiment, the slide-able element 140 can further comprise a concave portion positioned at the end of the slide-able element 140 closed to the second end 124 of the body. The mentioned concave portion can be employed to assist assembling the elastic element 160 at the predetermined position.

The hanger device 100 according to this embodiment can further comprise at least one hook. The hook(s) can be positioned onto the body 120 or/and the slide-able element 140. In one preferred example of this embodiment, the hanger device 100 can further comprise one pair of hook 144, and the mentioned hooks 144 are positioned on the outside of the slide-able element 140 as shown in FIG. 1 and FIG. 2. The mentioned hooks 144 can be employed for hanging. According to this present example, more preferably, the mentioned hooks 144 can be employed to slide the slide-able element 140. For example, through the hooks 144, the slide-able can be slid toward the second end 124 by the track 126, so that the first hook-shaped portion 128 and the second hook-shaped portion 142 can be employed to clip onto a desired position.

In another preferred example of this embodiment, the hanger device can further comprise at least one hook 1242. The mentioned hook(s) is/are positioned at the outside wall of the second end 124 of the body. The hook 1242 can be employed for hanging.

In order to further illustrating the hanger device according to this application, a practicing example is described as the following. However, the scope of the present invention is expressly not limited by the following example.

When putting the first hook-shaped portion 128 into a vent and sliding the slide-able element 140 toward the second end 124 by the hooks 144, the elastic element 160 can push the slide-able element 140 toward the first end 122 to a proper position, so that the first hook-shaped portion 128 and the second hook-shaped portion 142 will clip onto one blade in the vent. Then, the hanger device 100 can be clipped in a vent. In one preferred example, the mentioned vent can be an air-condition vent of a vehicle. In another preferred example, the mentioned vent can be an air-condition vent in a building. After clipping the hanger device 100 in a vent, the hook(s) positioned on the body 120 and the slide-able element 140 can still be employed for hanging desired thing with proper weight. For instance, after clipping the hanger device 100 in a vent, the hook(s) can be employed for hanging performing element(s), so that the air from the vent can carry some aroma therein. In another example, the hook(s) of the hanger device 100 can be employed for hanging some decorations. In still another example, the hook(s) of the hanger device 100 can be employed for hanging small bag to take some pins, such as garbage or scraps of paper.

To sum up, this present application discloses a hanger device. The mentioned hanger device comprises a body, a slide-able element, and an elastic element. With the hook-shaped portions of the body and the slide-able element, and the setting of the elastic element, the hanger device of this application can provide an adjust-able clip, so that the hanger device can be solidly clipped onto the desired position with different thickness. More preferably, the hanger device can not only be suitable to clip onto several desired position with different thickness, but also provide at least a hook on the hanger device for hanging thing with proper weight.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A hanger device comprising:
a body, wherein the body comprises a first end, a second end, and a track, wherein the first end and the second end are respectively positioned at opposite side of the body, wherein the track is positioned between the first end and the second end, wherein the first end comprises a first hook-shaped portion;
a slide-able element, wherein the slide-able element comprises an assembling portion and a second hook-shaped portion, wherein the slide-able element is assembled onto the track of the body through the assembling portion, wherein the second hook-shaped portion of the slide-able element and the first hook-shaped portion are employed to form an adjust-able clip;
an elastic element, wherein the elastic element is positioned between the second end of the body and the slide-able element.

2. The hanger device according to claim 1, wherein the body further comprises a protruding portion, wherein the protruding portion is positioned at the inside wall of the second end of the body, wherein the protruding portion is employed to assist assembling the elastic element at a predetermined position.

3. The hanger device according to claim 1, wherein the slide-able element further comprises a concave portion, wherein the concave portion is positioned at the end of the slide-able element closed to the second end of the body, wherein the concave portion is employed to assist assembling the elastic element at a predetermined position.

4. The hanger device according to claim 1, wherein the hanger device further comprises at least one hook positioned at the outside wall of the second end of the body.

5. The hanger device according to claim 1, wherein said slide-able element further comprises at least one hook, wherein the hook(s) is/are positioned on the outside of the slide-able element.

6. The hanger device according to claim 1, wherein said elastic element is a spring.
